(19) United States
(12) Patent Application Publication
(10) Pub. No.: US 2002/0059081 A1
(43) Pub. Date: May 16, 2002

(54) Health control system and information processing apparatus

(76) Inventors: Masashi Yasuda, Osaka (JP); Hirokazu Genno, Osaka (JP); Fumiiki Yoneda, Osaka (JP); Kenji Ueyama, Osaka (JP); Masakazu Asano, Osaka (JP)

Correspondence Address: BIRCH STEWART KOLASCH & BIRCH, PO BOX 747, FALLS CHURCH, VA, 22040-0747, US

(21) Appl. No.: 09/987,656

(22) Filed: Nov. 15, 2001

(30) Foreign Application Priority Data
Nov. 15, 2000 (JP) 2000-348789

(51) Int. Cl. G06F 17/60

(52) U.S. Cl. 705/3

(57) ABSTRACT

A communication device for health control acquires pulse data, electrocardiogram data, respiration data, acceleration data, weight data, blood pressure data, and temperature data of a patient. The communication device for health control carries out dialogic diagnosis on the patient by voice, and thereby acquires reply data indicating the dialogic diagnosis result. The data is transmitted to an information processing apparatus. The information processing apparatus evaluates the health condition of the patient on the basis of the data. The evaluation result is notified to the patient, the doctor, and the visiting nurse.

### BACKGROUND OF THE INVENTION

1. Field of the Invention

The present invention relates to a patient-health control system for assisting a doctor to diagnose the health condition of a patient, and an information processing apparatus used in the health control system.

2. Description of the Related Art

Daily health control is important for the home treatment against life habit disease, such as diabetes, and for the health care of elderlies. These persons such as patients of life habit disease and other elderlies (referred to as patients, hereafter) need to understand their own health condition. They need to go to hospital regularly to improve their health condition. Further, they need to control their own health condition according to the diagnosis by the doctors.

In this case, in particular, the necessity that the patients frequently go to hospital causes mental and physical burdens on the patients. Also caused is the problem of an increase in medical expenses. In addition, dialogic diagnosis on the patients by the doctors and the measurement of the blood pressure and the pulse carried out when the patients regularly come to the hospital are insufficient to understand the daily health condition of the patients outside the hospital. This causes a difficulty in accurate diagnosis on the patients.

Recently, computerization of diagnosis information such as chart information is in progress in large hospitals. Such computerization needs an expensive computer system. Thus, for a small clinics, there has been a difficulty in introducing such an expensive computer system.

Further, depending on the health condition of patients, nursing is necessary. Visit nursing for such patients is carried out by visit nursing companies. Nevertheless, also in this case, dialogic diagnosis and the measurement of the blood pressure and the pulse carried out when the nurses visit for nursing are insufficient to understand the daily health condition of the patients in the time other than the visit nursing. This causes a difficulty in appropriate nursing.

An apparatus has been developed in which a computer displays a plurality of questions for dialogic diagnosis onto a display screen in order to acquire the daily health condition of a patient, and then the patient replies via a keyboard, whereby simplified diagnosis is carried out on the basis of the reply. Nevertheless, in the use of such an apparatus, there has been the problem of causing a burden to those persons, such as elderlies, who are not familiar with operating a computer.

In some cases, the pulse and the blood pressure of a patient are measured with a tonometer and a pulsometer provided in the home or the like of the patient, whereby the daily health condition of the patient is acquired. Nevertheless, there has been the problem that the pulse and the blood pressure of the patient can not be measured outside the home.

### BRIEF SUMMARY OF THE INVENTION

The present invention has been devised with considering the above-mentioned problems.

A first object of the invention is to provide a health control system in which a communication device for health control acquires information of health condition indicating the health condition of a patient and then transmits the information of health condition to an information processing apparatus, whereby the information processing apparatus evaluates the health condition of the patient on the basis of the information of health condition and then notifies the result to the patient, the physician in attendance, and the like, and whereby the patients and the doctor can easily understand the daily health condition of the patient. Further, the invention provides a health control system in which when a doctor diagnoses the health condition of a patient, the doctor can more accurately do so on the basis of the evaluation result notified by an information processing apparatus.

A second object of the invention is to provide a health control system in which a communication device for diagnosis used for diagnosis on a patient by a doctor transmits and stores chart information indicating the chart of the patient into an information processing apparatus, whereby even a small clinic and the like can computerize the charts at a low cost.

A third object of the invention is to provide a health control system in which an information processing apparatus transmits information of evaluation result indicating the evaluation result of the health condition of a patient to a communication device for nursing used for nursing of the patient, whereby the health condition of the patient is notified to a nurse, and whereby the nurse can understand the daily health condition of the patient and thereby provide an appropriate nursing corresponding to the health condition of the patient.

A fourth object of the invention is to provide a health control system in which a communication device for health control outputs voice messages for dialogic diagnosis, and then the contents of the patient's reply is recognized by means of voice recognition, whereby dialogic diagnosis is carried out without complicated operation by the patient.

A fifth object of the invention is to provide a health control system in which a communication device for health control is provided with a portable detection unit capable of detecting physiology information such as the pulse, the blood pressure, and the like of a patient and attachable to the body of the patient, whereby the physiology information can be acquired even when the patient goes out.

In the invention, a communication device for health control acquires information of health condition indicating the health condition of a target person. The information of health condition is transmitted to an information processing apparatus. The information processing apparatus evaluates the health condition of the target person on the basis of the information of health condition. The result is notified to the target person, the physician in attendance, and the like. By virtue of this, the daily health condition of the target person is easily understood. Further, when the doctor diagnoses the health condition of the target person, the doctor can more accurately do so on the basis of the evaluation result notified by the information processing apparatus.

The above-mentioned notification of the evaluation result to the target person can be carried out by sending a document or the like indicating the evaluation result to the target person by facsimile, mail, or the like. In this case, the target person does not need to provide a new device for receiving the evaluation result from the information processing apparatus, and can use the health control system at a low cost.

Similarly, the notification of the evaluation result to the doctor can be carried out by sending a document or the like indicating the evaluation result to the doctor by facsimile, mail, or the like. In this case, without the necessity of introducing an expensive computer system, even a small clinic and the like can use the health control system at a low cost.

Further, in the invention, a communication device for health control receives information of evaluation result transmitted from an information processing apparatus, and then notifies the evaluation result to a target person. Accordingly, when the information processing apparatus generates the information of evaluation result and then transmits the information automatically to the communication device for health control, the evaluation result is automatically notified to the target person.

In the invention, a communication device for diagnosis receives information of evaluation result transmitted from an information processing apparatus, and then notifies the evaluation result to a doctor. Accordingly, when the information processing apparatus generates the information of evaluation result and then transmits the information automatically to the communication device for diagnosis, the evaluation result is automatically notified to the doctor.

In the invention, a communication device for diagnosis used for diagnosis on a target person by a doctor transmits and stores chart information indicating the chart of the target person into an information processing apparatus, whereby even a small clinic and the like can computerize the charts at a low cost.

In the invention, the health condition of a target person is notified to a nurse. Accordingly, the nurse can understand the daily health condition of the target person and thereby provide an appropriate nursing corresponding to the health condition of the target person.

In the invention, a dialogic diagnosis unit carries out dialogic diagnosis on a target person. Further, a detection unit detects physiology information such as the pulse, the blood pressure, and the like of the target person. Accordingly, the health condition of the target person is evaluated on the basis of the result of dialogic diagnosis and the physiology information. This permits a sufficiently accurate evaluation of the health condition.

In the invention, a voice generating unit outputs voice messages for dialogic diagnosis. Then, a voice recognizing unit recognizes the contents of the reply from a target person by means of voice recognition. This permits easy dialogic diagnosis without complicated operation by the target person.

In the invention, a detection unit is portable and attachable to the body of a target person. Accordingly, physiology information can be acquired even when the target person goes out.

In the invention, accounting information indicating a charge on a target person is calculated depending on the information provided to the target person. Accordingly, the charge corresponding to the information provided to the target person is collected. Further, in case that the accounting information is calculated automatically, the work of calculating the charge on the target person is eliminated.

In the invention, when a doctor uses a communication device for diagnosis, accounting information indicating a charge on the doctor is calculated depending on the use. Accordingly, the charge corresponding to the management of chart information and the like is collected. Further, in case that the accounting information is calculated automatically, the work of calculating the charge on the doctor is eliminated.

In the invention, accounting information indicating a charge on a nurse is calculated depending on the information provided to the nurse. Accordingly, the charge corresponding to the information provided to the nurse is collected. Further, in case that the accounting information is calculated automatically, the work of calculating the charge on the nurse is eliminated.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram showing the configuration of the main part of a health control system according to Embodiment 1;

FIG. 2 is a schematic diagram showing an example of a communication device for health control;

FIG. 3 is a block diagram showing the configuration of a main body;

FIG. 4 is a block diagram showing the configuration of an information processing apparatus;

FIG. 5 is a flowchart showing the procedure of a health control system according to Embodiment 1;

FIG. 6 is a flowchart showing the procedure of a health control system according to Embodiment 1;

FIG. 7 is a flowchart showing the procedure of a health control system according to Embodiment 1;

FIG. 8 is a flowchart showing the procedure of a health control system according to Embodiment 1;

FIG. 9 is a flowchart showing the procedure of dialogic diagnosis process;

FIG. 10 is a table showing an example of questions on life habit;

FIG. 11 is a table showing an example of questions on physical condition;

FIG. 12 is a flowchart showing the procedure of operation process of calorie consumption;

FIG. 13 is a graph showing pulse data and acceleration data;

FIG. 14 is a flowchart showing the procedure of operation process of aerobics hours;

FIG. 15 is a flowchart showing the procedure of operation process of sleeping hours;

FIG. 16 is a flowchart showing the procedure of operation process of stress hours;

FIG. 17 is a flowchart showing the procedure of operation process of daily life rhythm;

FIG. 18 is a flowchart showing the procedure of evaluation process of health condition;

FIG. 19 is a flowchart showing the procedure of evaluation process of health condition;

FIG. 20 is a flowchart showing the procedure of evaluation process of dialogic diagnosis;

FIG. 21 is a schematic diagram showing the configuration of the main part of a health control system according to Embodiment 2;

FIG. 22 is a block diagram showing the configuration of a communication device for diagnosis;

FIG. 23 is a flowchart showing the procedure of a health control system according to Embodiment 2;

FIG. 24 is a flowchart showing the procedure of a health control system according to Embodiment 2;

FIG. 25 is a flowchart showing the procedure of a health control system according to Embodiment 2; and

FIG. 26 is a flowchart showing the procedure of a health control system according to Embodiment 2.

### DESCRIPTION OF THE PREFERRED EMBODIMENTS

### Embodiment 1

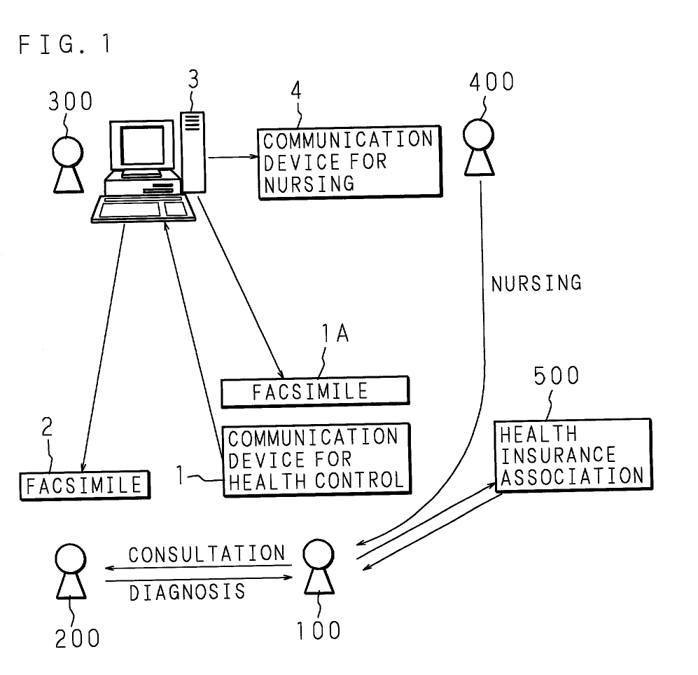

FIG. 1 is a schematic diagram showing the configuration of the main part of a health control system according to Embodiment 1. The health control system according to Embodiment 1 is a system for the health control of a patient 100. The system includes: a doctor 200; a service provider 300 such as a company which provides services on the management of the information used for the health control of the patient and the diagnosis on the patient by the doctor 200; a health insurance association 500 involving the patient 100 as an association member; and a visiting nurse 400 such as a company which provides visit nursing to the patient 100. The health control system further comprises: a communication device 1 for health control and a facsimile machine 1A provided in the home of the patient 100; a facsimile machine 2 provided in a hospital or clinic; an information processing apparatus 3 provided on the service provider 300 side; and a communication device 4 for visit nursing provided on the visiting nurse 400 side.

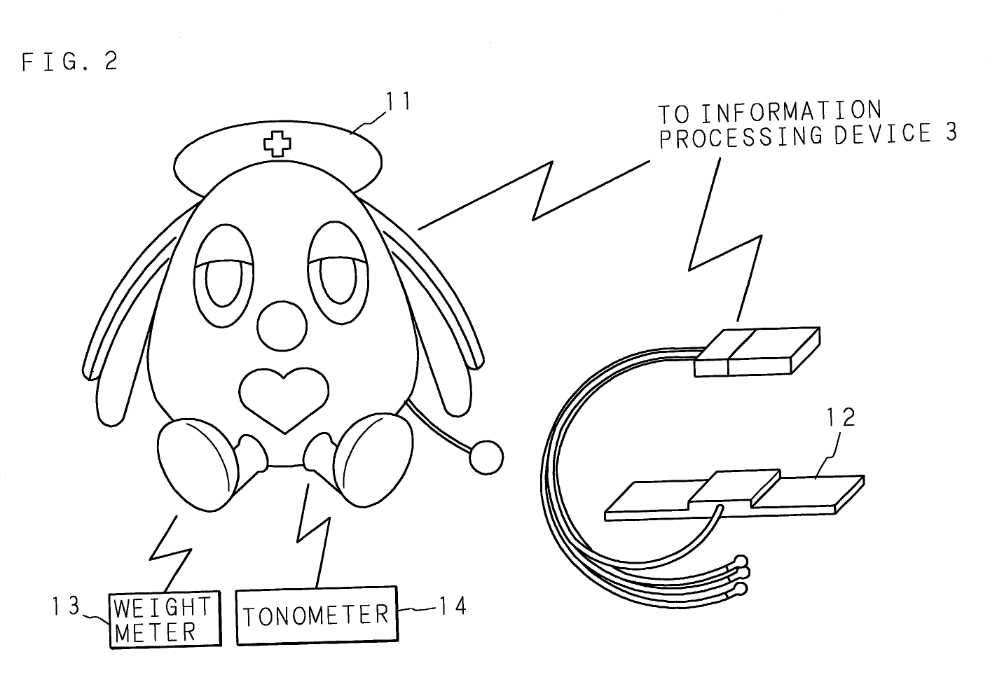

FIG. 2 is a schematic diagram showing an example of the communication device 1 for health control. The communication device 1 for health control comprises: a main body 11 the appearance of which is shaped like a pet in order for the patient 100 to feel familiar; and a vital sensor (detection unit) 12 which has a shape permitting it to be attached to the body of the patient 100 and detects the pulse of the patient 100. The vital sensor 12 comprises a pulsometer, an electrocardiometer, a spirometer, and a three-axis accelerometer (not shown). The three-axis accelerometer measures the acceleration of the patient 100 in the front-back direction (X-axis direction), the right-left direction (Y-axis direction), and the up-down direction (Z-axis direction). When the patient 100 wears the vital sensor 12 on his body, the sensor measures the pulse, the electrocardiogram, the respiration, and the acceleration all day long. The pulse data, the electrocardiogram data, the respiration data, and the acceleration data obtained by the measurements are transmitted together with patient identifying information for identifying the patient 100, to the information processing apparatus 3 by a PHS (Personal Handy-phone System) communication device (not shown) built in the vital sensor 12.

A weighing scale 13 and a tonometer 14 are provided in the home of the patient 100. The body weight data and the blood pressure data obtained by these devices are transmitted to the main body II by wireless communications using weak radio waves.

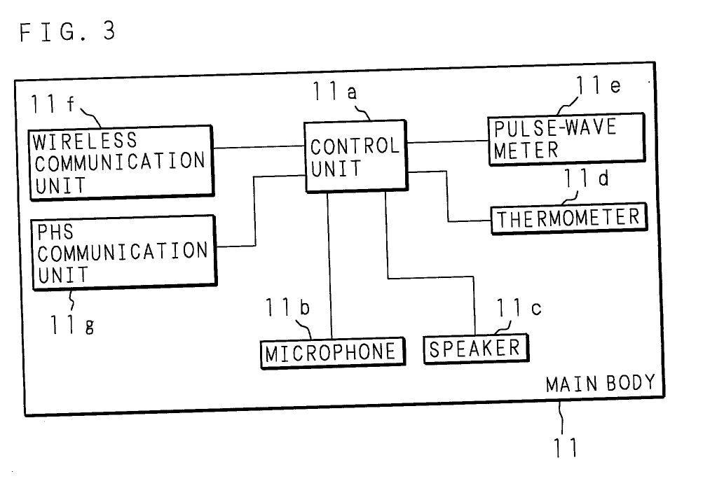

FIG. 3 is a block diagram showing the configuration of the main body 11. The main body 11 comprises a control unit 11a, a microphone 11b, a speaker 11c, a thermometer 11d, a sphygmometer 11e, a wireless communication unit 11f, and a PHS communication unit 11g. The microphone 11b and the speaker 11c are embedded in the face portion of the main body 11. The thermometer 11d is built in the tail portion of the main body 11. The sphygmometer 11e is built in the left arm portion of the main body 11. When the patient 100 touches the tail of the main body 11, the thermometer 11d measures the temperature of the patient 100, while when the patient 100 touches the left arm of the main body 11, the sphygmometer 11e measures the pulse waves of the patient 100.

The main body 11 can output a voice from the speaker 11c, and outputs voice messages indicating questions for dialogic diagnosis from the speaker 11c. The contents of the reply (“Yes” or “No”) by the patient 100 to the questions is input via the microphone 11b. The control unit 11a recognizes the input by voice recognition, and thereby understands the reply contents. Then, the PHS communication unit 11g transmits: the weight data and the blood pressure data which are input to the main body 11 from the weighing scale 13 and the tonometer 14, respectively; the temperature data and the pulse wave data measured by the thermometer 11d and the sphygmometer 11e, respectively; and the reply data indicating the contents of the reply by the patient 100 to the dialogic diagnosis by the main body 11; together with the patient identifying information, to the information processing apparatus 3.

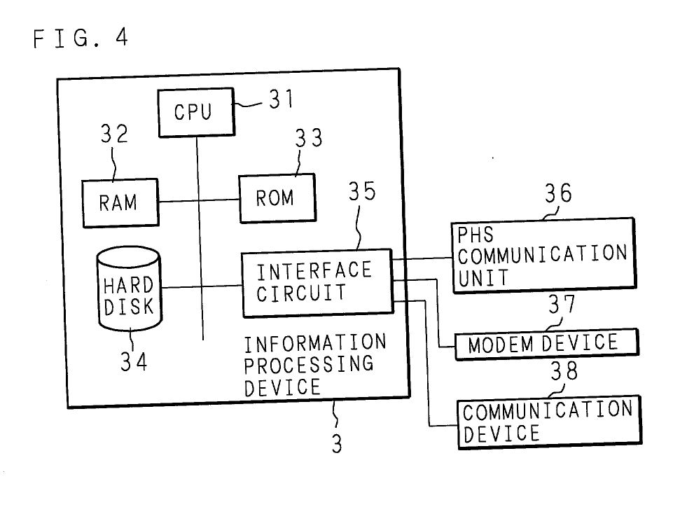

FIG. 4 is a block diagram showing the configuration of the information processing apparatus 3. The information processing apparatus 3 comprises a CPU 31, a RAM 32, a ROM 33, a hard disk drive 34, and an interface circuit 35. The interface circuit 35 is connected to: a PHS communication device 36 for communicating with the communication device 1 for health control; a modem device 37 for communicating with the facsimile machine 2; and the Internet. The interface circuit 35 is connected to the Internet via a communication device 38 for communicating with the communication device 4 for nursing which is also connected to the Internet.

The information processing apparatus 3 receives data (information of health condition) from the communication device 1 for health control via the PHS communication device 36. The data is input via the interface circuit 35. On the basis of the patient identifying information contained in the data, a personal file for the patient is selected among the files stored in the hard disk drive 34, whereby the input data is stored into the personal file.

With storing the data received from the communication device 1 for health control, the information processing apparatus 3 evaluates the health condition of the patient 100 on the basis of the data. The evaluation result is transmitted from the modem device 37 to the facsimile machine 1A, and thereby notified to the patient 100. At the same time, the evaluation result is transmitted to the facsimile machine 2, and thereby notified to the doctor 200. Further, the evaluation result is transmitted via the Internet to the communication device 4 for nursing, and thereby notified to the visiting nurse 400.

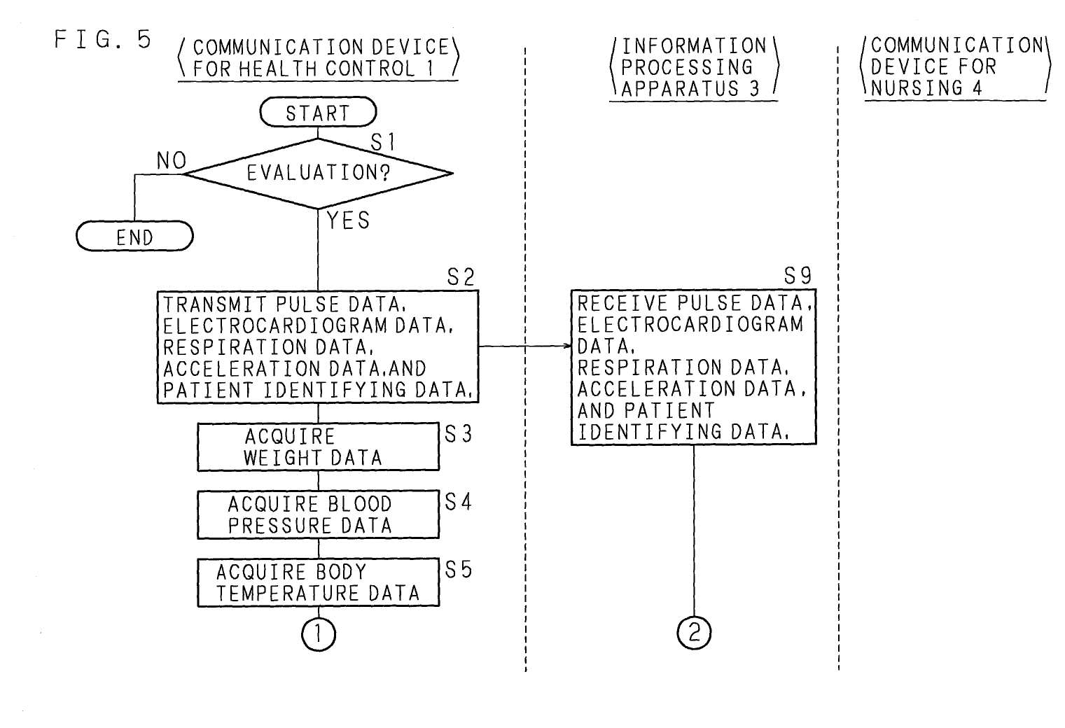

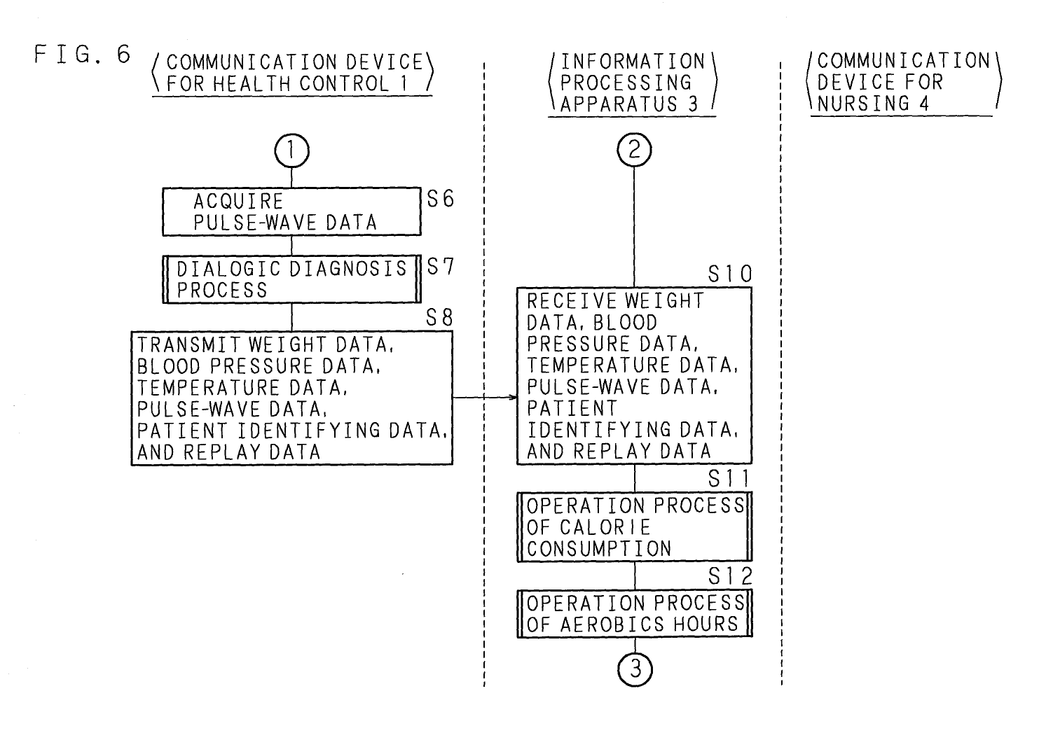

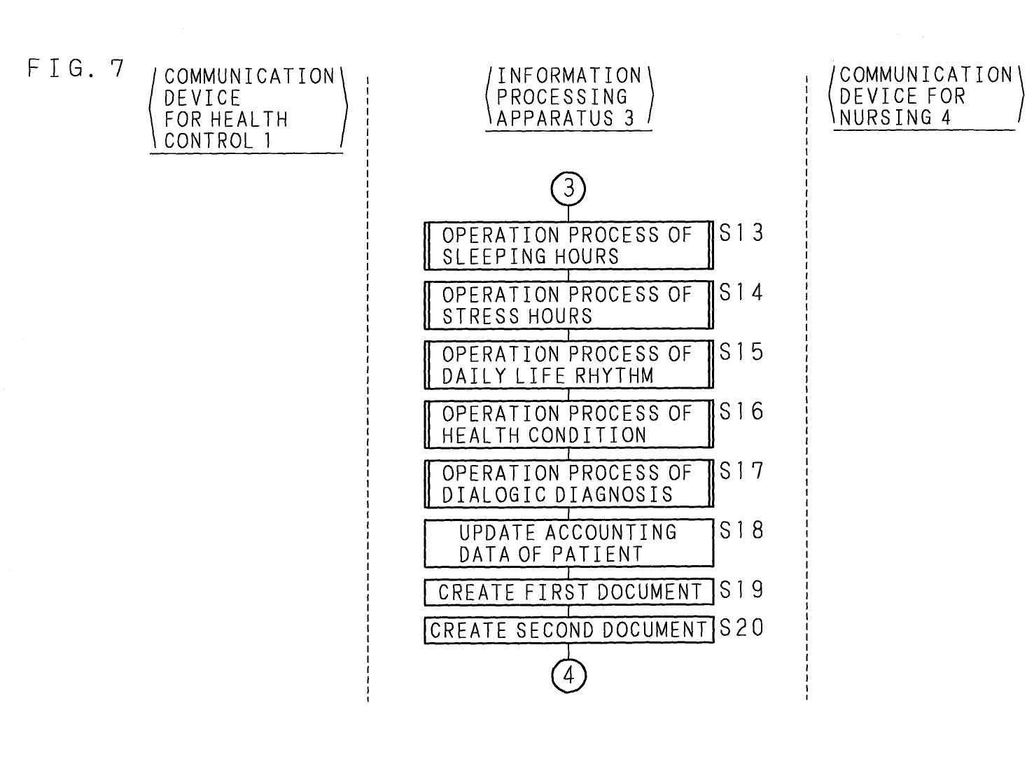

The procedure of the health control system according to Embodiment 1 is described below. FIGS. 5-8 are flowcharts showing the procedure of the health control system according to Embodiment 1. At a predetermined time of day (such as 10 PM), the communication device 1 for health control outputs a voice message from the main body 11 and thereby inquires of the patient 100 whether to apply for the evaluation of the health condition (Step 1). The main body 11 recognizes the reply to the question by means of voice recognition using a known technique such as pattern matching. When the patient 100 replies so as not to apply for the evaluation, the procedure terminates. In contrast, when the patient 100 replies so as to apply for the evaluation, the vital sensor 12 transmits the pulse data, the electrocardiogram data, the respiration data, and the acceleration data together with the patient identifying information for specifying the patient 100, to the information processing apparatus 3 (Step 2). At the same time, the main body 11 acquires the weight data, the blood pressure data, the temperature data, and the pulse wave data (Steps 3-6), and then carries out dialogic diagnosis described later (Step 7) and thereby acquires reply data indicating the reply by the patient 100 to the dialogic diagnosis. Then, the main body 11 transmits the weight data, the blood pressure data, the temperature data, the pulse wave data, and the reply data obtained as described above, together with the patient identifying information, to the information processing apparatus 3 (Step 8).

In Step 2, the pulse data, the electrocardiogram data, the respiration data, and the acceleration data of the day (for example, from 10 PM of the previous day to 10 PM of the present day) are transmitted at a predetermined time of day (such as 10 PM).

In Step 3, the main body 11 outputs a voice message (such as “Please measure your weight”) requesting the weight measurement, at a predetermined time of day (such as 10 PM). This causes the patient 100 to measure his weight using the weighing scale 13. The weighing scale 13 transmits the measurement result to the main body 11, and then the main body 11 receives the result. As such, the weight data is acquired. Similarly, in Step 4, after the weight data is acquired, the main body 11 outputs a voice message requesting the blood pressure measurement. This causes the patient 100 to use the tonometer 14. The blood pressure data transmitted from the tonometer 14 is received by the main body 11, whereby the blood pressure data is acquired.

In Step 5, after the blood pressure data is acquired, the main body 11 outputs a voice message (such as “Please touch my tail”) requesting the temperature measurement. This causes the patient 100 to touch the thermometer 11d, whereby the temperature data is acquired. Similarly, in Step 6, after the temperature data is acquired, the main body 11 outputs a voice message (such as “Please touch my left arm”) requesting the pulse wave measurement. This causes the patient 100 to touch the sphygmometer 11e for a predetermined time (such as one minute), whereby the pulse wave data is acquired.

The information processing apparatus 3 receives the pulse data, the electrocardiogram data, the respiration data, the acceleration data, and the patient identifying information (Step 9), and then receives the weight data, the blood pressure data, the temperature data, and the pulse wave data, the reply data, and the patient identifying information (Step 10). On the basis of these data, the information processing apparatus 3 carries out the operation process of calorie consumption, the operation process of aerobics hours, the operation process of sleeping hours, the operation process of stress hours, the operation process of daily life rhythm, the evaluation process of health condition, and the evaluation process of dialogic diagnosis (Steps 11-17).

In the information processing apparatus 3, patient accounting data indicating the charge to the patient 100 is stored in the hard disk drive 34 in association with the patient identifying information for the patient 100. The patient accounting data indicates the per-month total charge which is composed of a basic charge for the use of the health control system per month; and a charge which is the product between a per-usage charge for evaluation of the health condition of the patient 100 and the number of the use of evaluation within the month. The information processing apparatus 3 updates the patient accounting data into the sum between the amount indicated by the previous patient accounting data and one per-usage charge (Step 18).

In the information processing apparatus 3, patient facsimile data indicating the phone number for the facsimile machine of each patient and doctor facsimile data indicating the phone numbers for the facsimile machines of the physician in attendance for the patient are stored in the hard disk drive 34 in a manner corresponding to the patient identifying information for the patients. The information processing apparatus 3 generates a first document data of a document describing: the name; the weight; the calorie consumption obtained by the operation process of calorie consumption; the aerobics hours obtained by the operation process of aerobics hours; the sleeping hours and the deeply sleeping hours obtained by the operation process of sleeping hours; the stress hours obtained by the operation process of stress hours; the sleep begin time and the sleep end time obtained by the operation process of daily life rhythm; the evaluation result obtained by the evaluation process of health condition; and the dialogic diagnosis result obtained by the evaluation process of dialogic diagnosis of the patient 100 (Step 19). Further, the information processing apparatus 3 generates a second document data of a document describing: the name; the weight; the blood pressure; the temperature; the pulse wave; the calorie consumption; the aerobics hours; the sleeping hours; the stress hours; the sleep begin time and the sleep end time; and the dialogic diagnosis result of the patient 100 (Step 20). The information processing apparatus 3 transmits the first document data to the facsimile machine 1A according to the patient facsimile data (Step 21), and then transmits the second document data to the facsimile machine 2 according to the doctor facsimile data (Step 22). Further, the information processing apparatus 3 transmits data including: the name; the weight; the blood pressure; the temperature; the pulse wave; the calorie consumption; the sleeping hours; and the dialogic diagnosis result of the patient 100; to the communication device 4 for nursing (Step 23).

In the information processing apparatus 3, nurse accounting data indicating the charge to the visiting nurse 400 is stored in the hard disk drive 34. The nurse accounting data indicates the per-month total charge which is an amount corresponding to the number of services of providing information to the visiting nurse 400 within the month. The information processing apparatus 3 updates the nurse accounting data into the sum between the amount indicated by the previous nurse accounting data and one per-usage charge (Step 24). The communication device 4 for nursing receives the data (Step 25), outputs the data (Step 26), and then terminates the procedure.

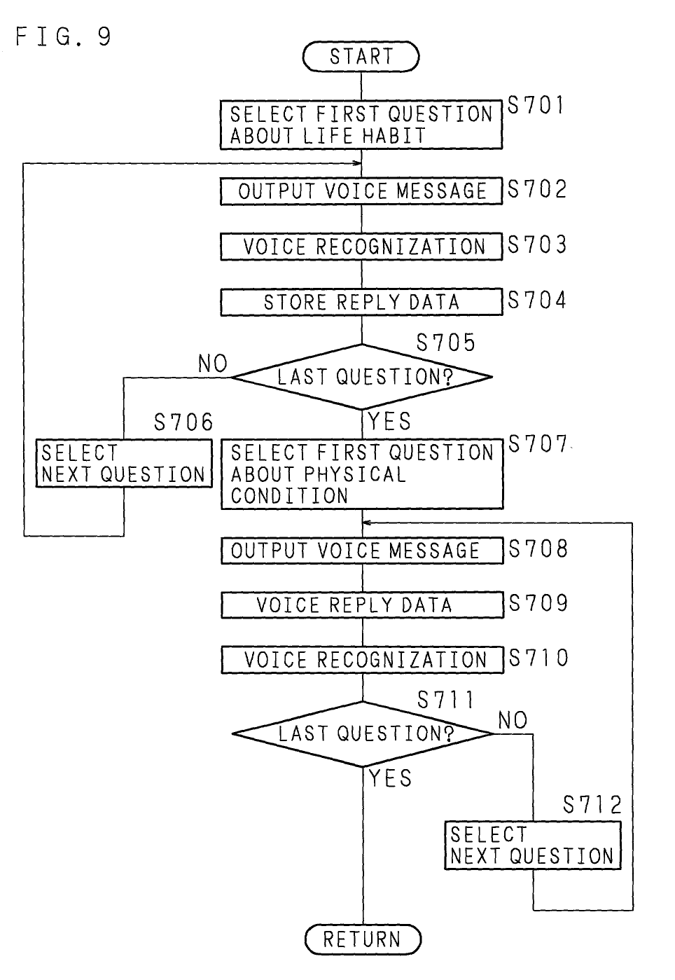

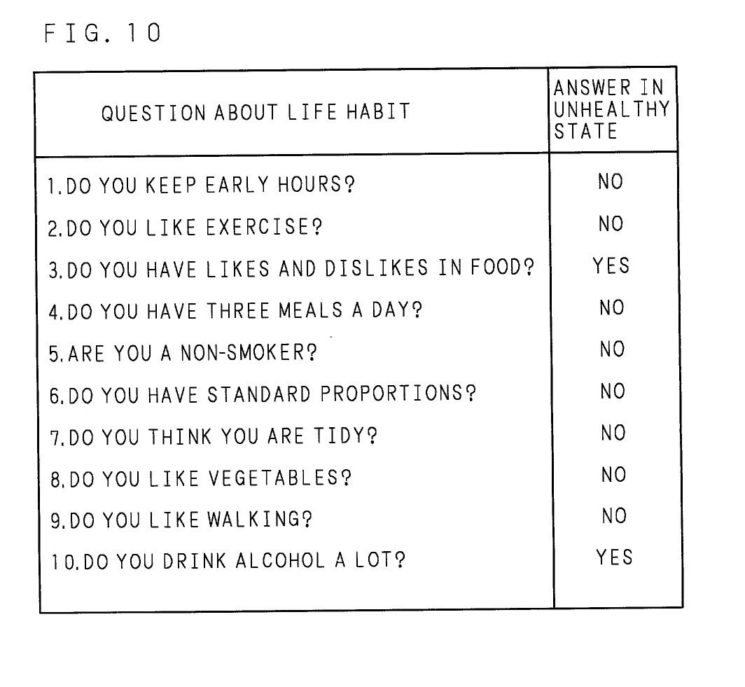

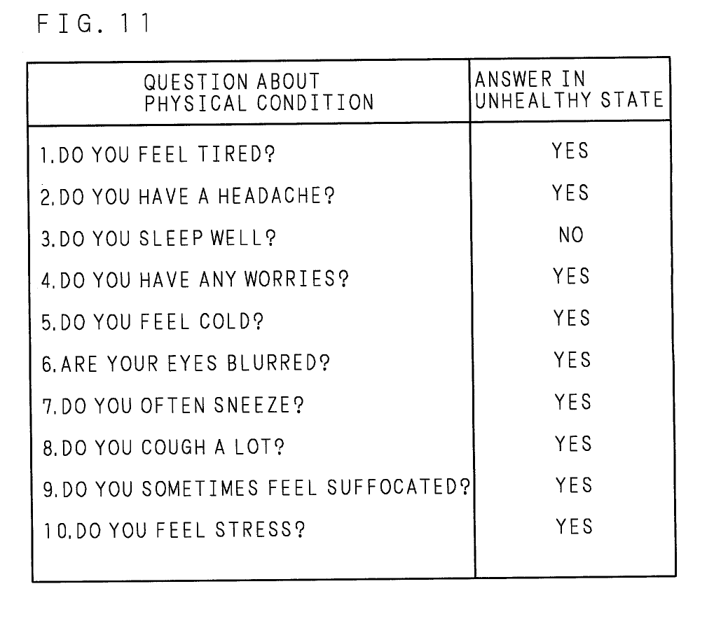

The procedure of dialogic diagnosis process is described below. FIG. 9 is a flowchart showing the procedure of dialogic diagnosis process. The control unit 11a of the main body 11 stores in advance a plurality of data sets indicating the questions for dialogic diagnosis. FIG. 10 is a table showing an example of questions on life habit, while FIG. 11 is a table showing an example of questions on physical condition. The main body 11 selects the first question among the questions on life habit shown in FIG. 10 (Step 701), and then outputs the question as a voice message (Step 702). When the patient 100 replies to the question (“Yes” or “No”), the reply is recognized by voice recognition (Step 703).

The recognition result is stored as reply data in association with the question number (Step 704). It is determined whether the selected question is the last one among the questions on life habit (Step 705). When it is not the last question, the next question is selected (Step 706), and the procedure returns to Step 702. When it is the last question in Step 705, the main body 11 selects the first question among the questions on physical condition shown in FIG. 11 (Step 707), and then outputs the question as a voice message (Step 708). Reply from the patient 100 is recognized by voice recognition (Step 709). The recognition result is stored as reply data in association with the question number (Step 710). It is determined whether the selected question is the last one among the questions on physical condition (Step 711). When it is not the last question, the next question is selected (Step 712), and the procedure returns to Step 708. When it is the last question in Step 711, the procedure returns.

Here, the question data shown in FIGS. 10 and 11 is renewed by new data regularly transmitted from the information processing apparatus 3.

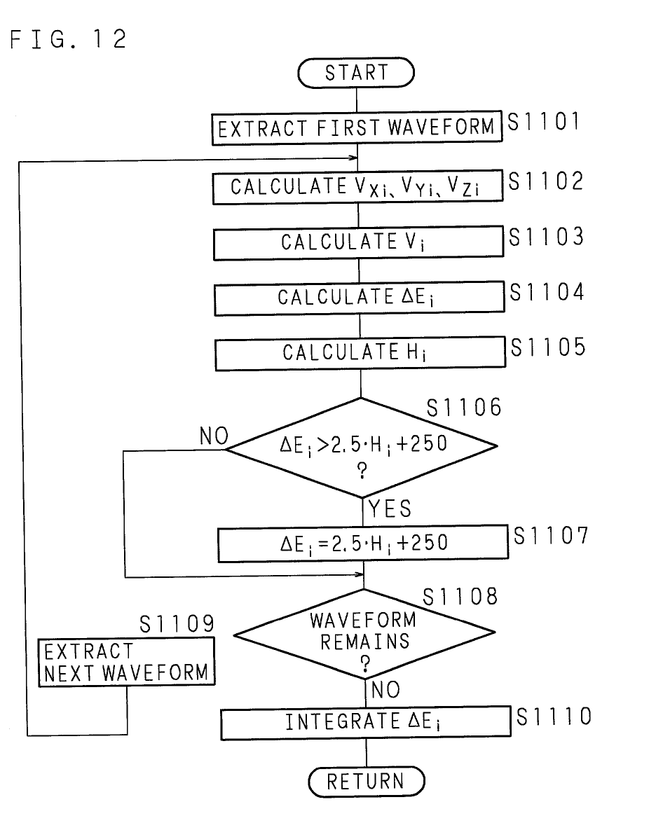

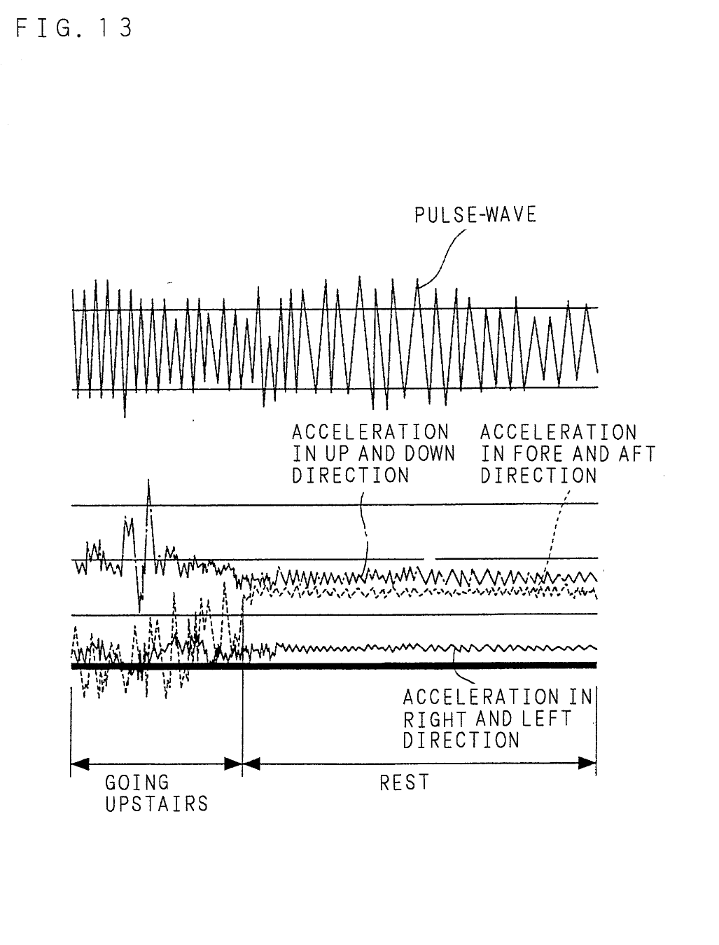

The operation process of calorie consumption is described below. FIG. 12 is a flowchart showing the procedure of the operation process of calorie consumption. FIG. 13 is a graph showing pulse data and acceleration data. As shown in FIG. 13, pulse data is expressed as a time series of pulse wave, while acceleration data is expressed as a time series of acceleration waveforms in the X-axis, Y-axis, and Z-axis directions. First, the information processing apparatus 3 extracts a pulse wave and acceleration waveforms in the X-axis, Y-axis, and Z-axis directions from the pulse wave data and the acceleration data during the first 10 seconds (Step 1101). Then, approximate velocity components VXi, VYi, and VZi in the X-axis, Y-axis, and Z-axis directions are calculated from the extracted three-axis acceleration waveforms (Step 1102). More specifically, the average of each acceleration component is calculated, and the absolute value of the difference between each average and the corresponding acceleration waveform is calculated. Then, the absolute value of the difference is integrated for each acceleration component. These integrated values give approximate velocity components VXi, VYi, and VZi.

After that, the norm (square root of the total of the squared value of every component) of the approximate velocity components VXi, VYi, and VZi is calculated according to Equation (1), whereby approximate velocity Vi is obtained (Step 1103).

Vi=√(VXi2+VYi2+VZi2) (1)

After the approximate velocity Vi is obtained, calorie consumption ΔEi during the 10 seconds in question is calculated according to Equation (2) (Step 1104).

ΔEi=(½)·W·Vi2+50 (2)

Here, W indicates the weight of the patient 100 obtained from the weight data. In Equation (2), the term (½)·W·Vi2 indicates the kinetic energy during the 10 seconds in question, while the term “50” indicates the basic metabolism during the 10 seconds in question. Thus, the calorie consumption ΔEi is obtained as the sum of these terms.

Next, average pulse rate Hi is calculated from the extracted pulse wave (Step 1105). More specifically, the time difference between two adjacent instances when the pulse wave is at maximum is divided by 60. Then, the reciprocal of the divided number gives an instantaneous pulse rate. Such calculation of an instantaneous pulse rate is repeated during the 10 seconds in question, and then a plurality of obtained instantaneous pulse rates are averaged out, whereby the average pulse rate Hi is calculated. After that, the calorie consumption ΔEi is compared with 2.5 ·Hi+250 (Step 1106). In general, calorie consumption ΔEi falls within the range of (2.5·Hi+100)±150 with respect to average pulse rate Hi. This is a relation found by experiments. Accordingly, when ΔEi>2.5·Hi+250 in Step 1106, it is determined that an external acceleration is exerted on the three-axis accelerometer by a vehicle or the like. In this case, the calorie consumption ΔEi is set to be 2.5·Hi+250 (Step 1107). In contrast, when ΔEi≦2.5·Hi−50 in Step 1106, it is determined that the patient 100 is under mental stress. In this case, the procedure goes to Step 1108 immediately.

Then, it is determined whether any yet-extracted pulse wave and three-axis acceleration waveforms remain (Step 1108). When the data remains, the pulse wave and the three-axis acceleration waveforms are extracted during the next 10 seconds (Step 1109). Then, the procedure returns to Step 1102. When the extraction is completed in Step 1108, the values of calorie consumption ΔEi in all 10-second durations are integrated (Step 1110), whereby calorie consumption ΔEi during the 24 hours is calculated. Then, the procedure returns.

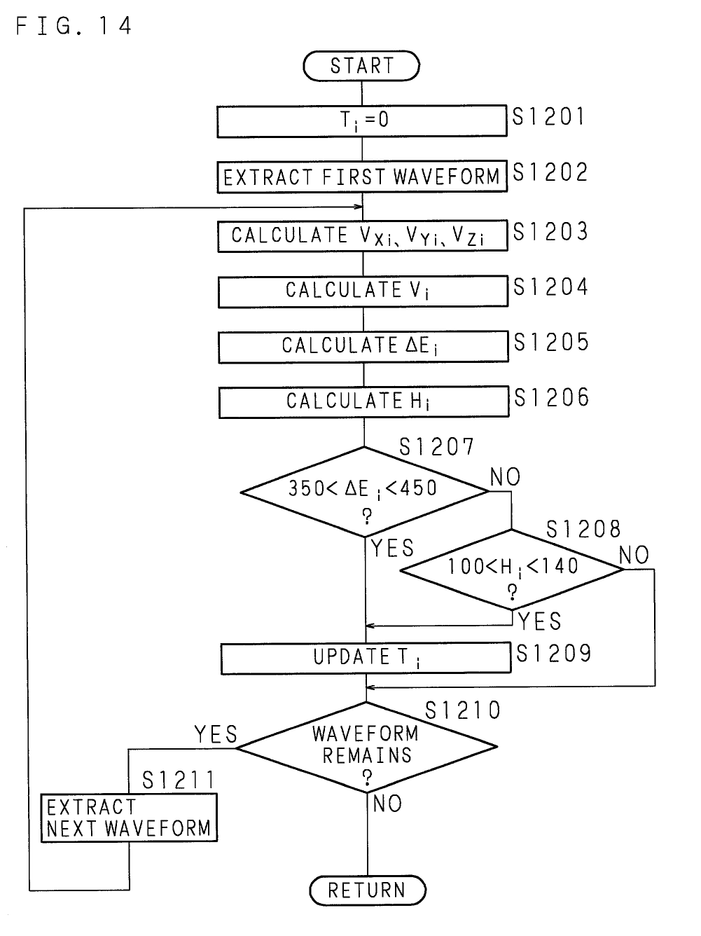

The operation process of aerobics hours is described below. FIG. 14 is a flowchart showing the procedure of the operation process of aerobics hours. First, aerobics hours Ti is set to be zero (Step 1206). The procedure in Steps 1202-1206 is similar to that in Steps 1101-1105, and hence the description is omitted. It is determined whether the calorie consumption ΔEi satisfies the condition 350<ΔEi<450 (Step 1207). When the condition is not satisfied, it is determined whether the average pulse rate Hi satisfies the condition 100<Hi<140 (Step 1208). When the condition in Step 1207 is satisfied, it is determined that aerobics is carried out during the 10 seconds in question. Similarly, when the condition in Step 1208 is satisfied, it is determined that the body is stationary during the 10 seconds in question, but that the stationary state is merely temporary during the aerobics. In these cases, the aerobics hours Ti is renewed, that is, the value of 10 seconds is added to the aerobics hours Ti (Step 1209). Then, the procedure goes to Step 1210. When the condition in Step 1208 is not satisfied, it is determined whether any yet-extracted pulse wave and three-axis acceleration waveforms remain (Step 1210). When the data remains, the pulse wave and the three-axis acceleration waveforms are extracted during the next 10 seconds (Step 1211). Then, the procedure returns to Step 1203. When the extraction is completed in Step 1210, the procedure returns.

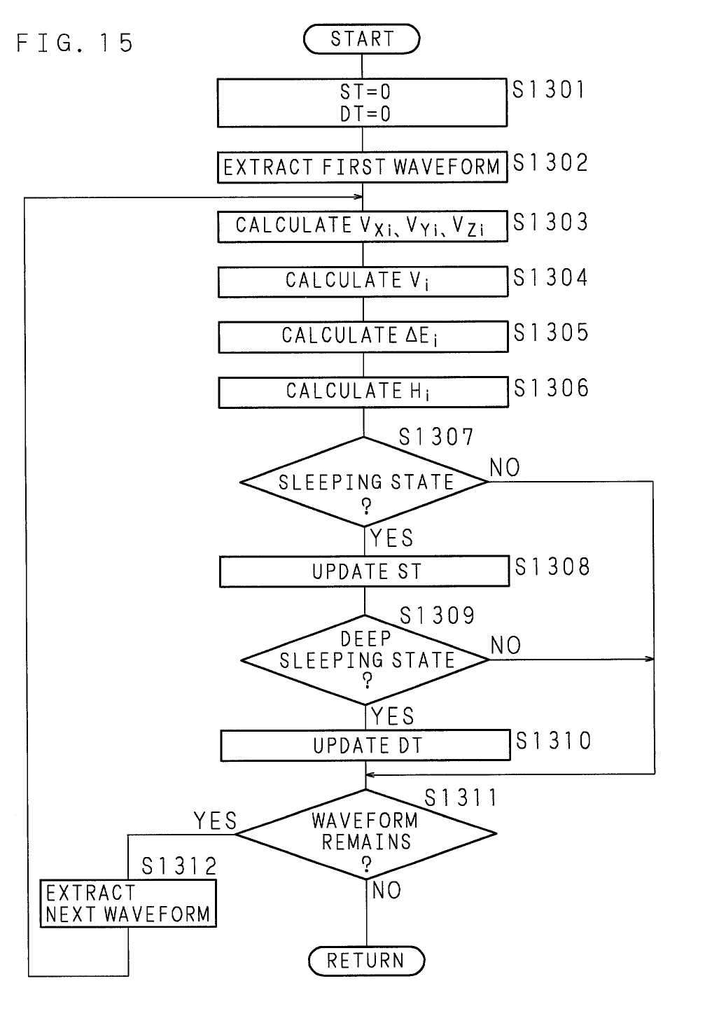

The operation process of sleeping hours is described below. FIG. 15 is a flowchart showing the procedure of the operation process of sleeping hours. First, sleeping hours ST and deeply sleeping hours DT are set to be zero (Step 1301). In Steps 1302-1306, the procedure is similar to that in Steps 1101-1105. However, the differences are: that the pulse wave and the three-axis acceleration waveforms are extracted during 5 minutes in Step 1302; that the calorie consumption ΔEi during the 5 minutes is calculated according to Equation (3) in Step 1305; and that the average pulse rate Hi is calculated in Step 1306 from a plurality of instantaneous pulse rates during these 5-minute durations.

ΔEi=30 ·{(½)·W·Vi2+50} (3)

It is determined whether the 5 minutes in question is of a sleep state (Step 1307). In this determination, when the calorie consumption ΔEi satisfies the condition ΔEi<125 and when the average pulse rate Hi satisfies the condition Hi<70, it is determined that the 5 minutes in question is of a sleep state. In contrast, when one or both of these conditions are not satisfied, it is determined that the 5 minutes in question is not of a sleep state. When it is of a sleep state in Step 1307, the value of 5 minutes is added to the sleeping hours ST (Step 1308). In contrast, when it is not of a sleep state in Step 1307, the procedure goes to Step 1309.

After that, it is determined whether the same 5 minutes is of a deep sleep state (Step 1309). In this determination, when the calorie consumption ΔEi satisfies the condition ΔEi<100 and when the average pulse rate Hi satisfies the condition Hi<60, it is determined that the 5 minutes in question is of a deep sleep state. In contrast, when one or both of these conditions are not satisfied, it is determined that the 5 minutes in question is not of a deep sleep state. When it is of a deep sleep state in Step 1309, the value of 5 minutes is added to the deeply sleeping hours DT (Step 1310). In contrast, when it is not of a deep sleep state in Step 1309, the procedure goes to Step 1311.

Then, it is determined whether any yet-extracted pulse wave and three-axis acceleration waveforms remain (Step 1311). When the data remains, the pulse wave and the three-axis acceleration waveforms are extracted during the next 5 minutes (Step 1312). Then, the procedure returns to Step 1303. When the extraction is completed in Step 1311, the procedure returns.

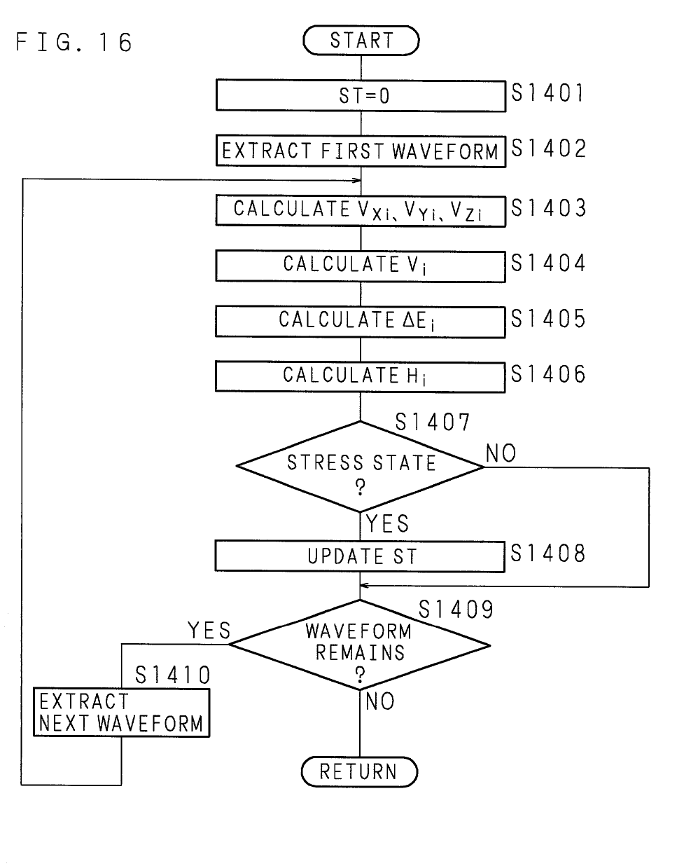

The operation process of sleeping hours is described below. FIG. 16 is a flowchart showing the procedure of the operation process of stress hours. First, stress hours St is set to be zero (Step 1401). The procedure in Steps 1402-1406 is similar to that in Steps 1101-1105. However, the differences are: that the pulse wave and the three-axis acceleration waveforms are extracted during 5 seconds in Step 1402; that the calorie consumption ΔEi during the 5 seconds is calculated according to Equation (4) in Step 1405; and that the average pulse rate Hi is calculated in Step 1406 from a plurality of instantaneous pulse rates during these 5-second durations.

ΔEi=(½)·{(½)·W·Vi2+50} (4)

It is determined whether the 5 seconds in question is of a stress state (Step 1407). In this determination, when the calorie consumption ΔEi satisfies the condition ΔEi<{(2.5·Hi+100)−150}·(½), it is determined that the 5 seconds in question is of a stress state. In contrast, when the condition is not satisfied, it is determined that the 5 seconds in question is not of a stress state. When it is of a stress state in Step 1407, the value of 5 seconds is added to the stress hours St (Step 1408). In contrast, when it is not of a stress state in Step 1407, the procedure goes to Step 1409.

Then, it is determined whether any yet-extracted pulse wave and three-axis acceleration waveforms remain (Step 1409). When the data remains, the pulse wave and the three-axis acceleration waveforms are extracted during the next 5 seconds (Step 1410). Then, the procedure returns to Step 1403. When the extraction is completed in Step 1409, the procedure returns.

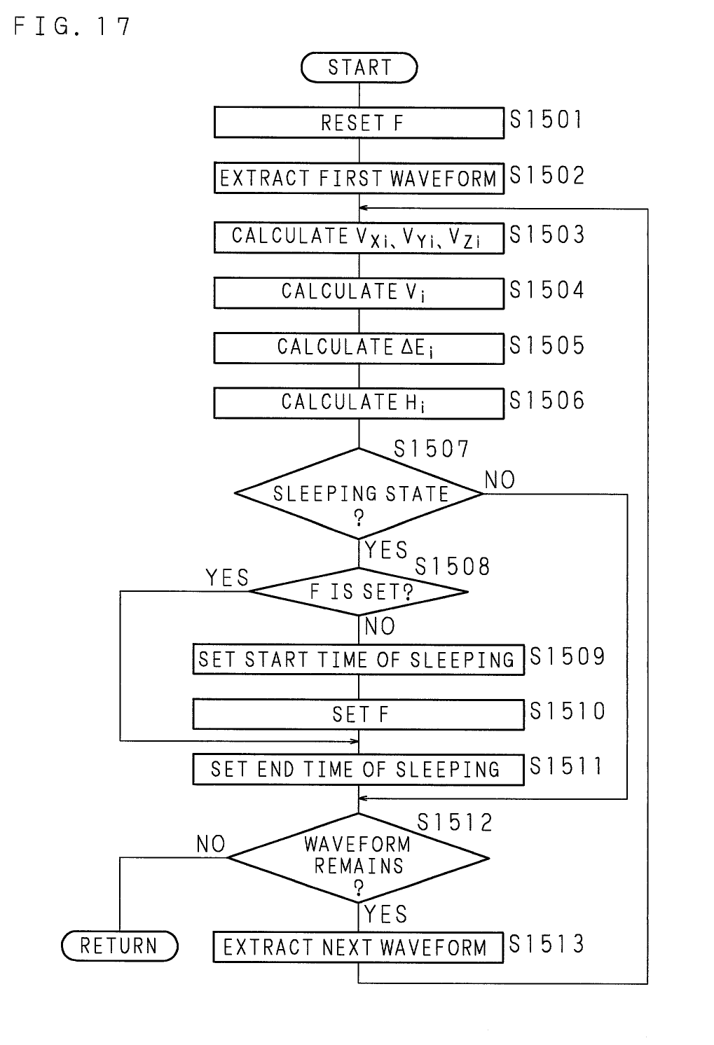

The operation process of daily life rhythm is described below. FIG. 17 is a flowchart showing the procedure of the operation process of daily life rhythm. First, a flag F is reset (Step 1501). The procedure in Steps 1502-1507 is similar to that in Steps 1302-1307, and hence the description is omitted. In Step 1507, when it is determined that the 5 minutes in question is of a sleep state, the state of the flag F is checked out (Step 1508). When the flag F is in the set state, the procedure goes to Step 1511. In contrast, when the flag F is in the reset state in Step 1508, the sleep begin time is set to be the begin time of the 5 minutes in question (Step 1509), and then the flag F is set (Step 1510). In Step 1507, when it is determined that the 5 minutes in question is not of a sleep state, the procedure goes to Step 1512.

Then, the sleep end time is set to be the end time of the 5 minutes in question (Step 1511). It is determined whether any yet-extracted pulse wave and three-axis acceleration waveforms remain (Step 1512). When the data remains, the pulse wave and the three-axis acceleration waveforms are extracted during the next 5 minutes (Step 1513). Then, the procedure returns to Step 1503. When the extraction is completed in Step 1512, the procedure returns.

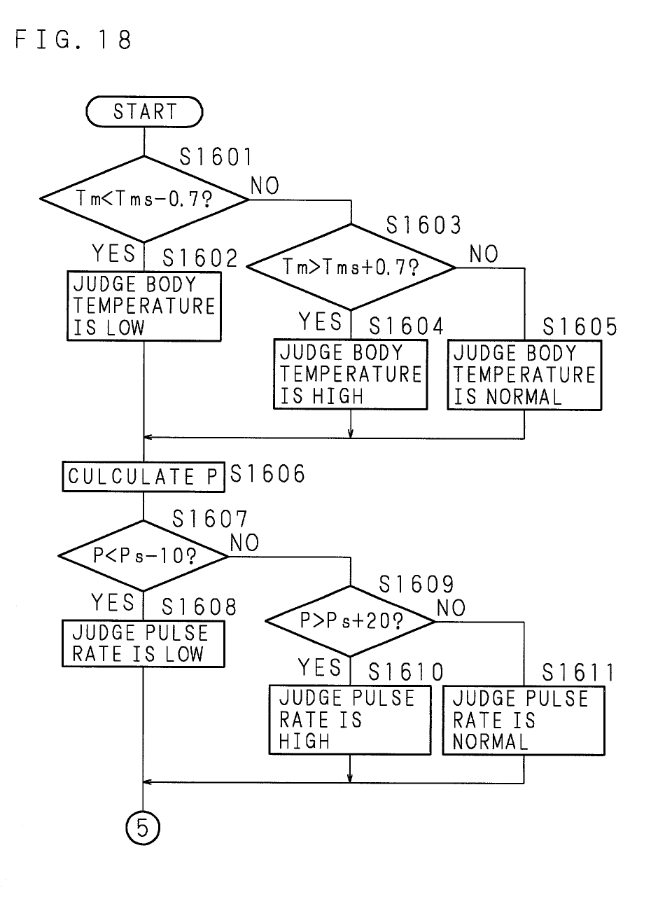

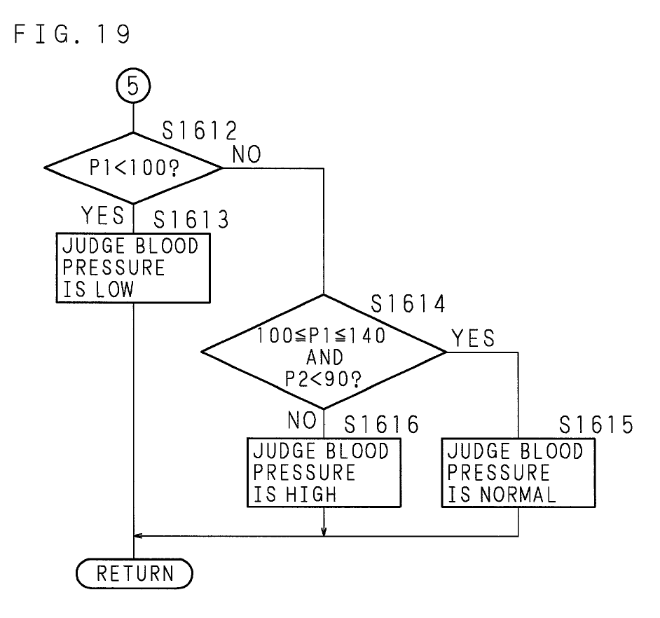

The evaluation process of health condition is described below. FIGS. 18 and 19 are flowcharts showing the procedure of the evaluation process of health condition. First, it is determined whether the temperature Tm of the patient 100 indicated by the temperature data satisfies the condition Tm<Tms−0.7 (Step 1601). Here, Tms indicates the standard temperature of the patient, and is a patient-dependent value. When the condition in Step 1601 is satisfied, it is determined that the temperature is low. In this case, data indicating the contents of “Your temperature is somewhat low. Please warm up your body” is generated as the evaluation result (Step 1602), and then the procedure goes to Step 1606. When the condition in Step 1601 is not satisfied, it is determined whether the condition Tm>Tms+0.7 is satisfied (Step 1603). When the condition in Step 1603 is satisfied, it is determined that the temperature is high. In this case, data indicating the contents of “You have a fever somewhat. Please take a rest” is generated as the evaluation result (Step 1604), and then the procedure goes to Step 1606. When the condition in Step 1603 is not satisfied, it is determined that the temperature is normal. In this case, data indicating the contents of “Your temperature is normal” is generated as the evaluation result (Step 1605).

By counting the number of peaks in the pulse wave data, pulse rate P per minute is calculated (Step 1606). It is determined whether the pulse rate P satisfies the condition P<Ps−10 (Step 1607). Here, Ps indicates the standard pulse rate of the patient, and is a patient-dependent value. When the condition in Step 1607 is satisfied, it is determined that the pulse rate P is low. In this case, data indicating the contents of “Your pulse rate is low” is added to the evaluation result (Step 1608), and then the procedure goes to Step 1612. When the condition in Step 1607 is not satisfied, it is determined whether the condition P>Ps+20 is satisfied (Step 1609). When the condition in Step 1609 is satisfied, it is determined that the pulse rate is high. In this case, data indicating the contents of “Your pulse rate is high. Please take a rest” is added to the evaluation result (Step 1610), and then the procedure goes to Step 1612. When the condition in Step 1609 is not satisfied, it is determined that the pulse rate is normal. In this case, data indicating the contents of “Your pulse rate is normal” is added to the evaluation result (Step 1611).

After that, it is determined whether the systolic blood pressure P1 of the patient 100 obtained by the blood pressure data satisfies the condition P1<100 (Step 1612). When the condition is satisfied, it is determined that the blood pressure is low. In this case, data indicating the contents of “Your blood pressure is low. Please take sufficient sleep and nutrition” is added to the evaluation result (Step 1613), and then the procedure returns. When the condition in Step 1612 is not satisfied, it is determined whether the condition 100≦P1≦140 is satisfied and whether diastolic blood pressure P2 obtained by the blood pressure data satisfies the condition P2<90 (Step 1614). When both conditions are satisfied, it is determined that the blood pressure is normal. In this case, data indicating the contents of “Your blood pressure is normal” is added to the evaluation result (Step 1615), and then the procedure returns. When any condition in Step 1614 is not satisfied, it is determined that the blood pressure is high. In this case, data indicating the contents of “Your blood pressure is high. Please consult with the doctor” is added to the evaluation result (Step 1616), and then the procedure returns.

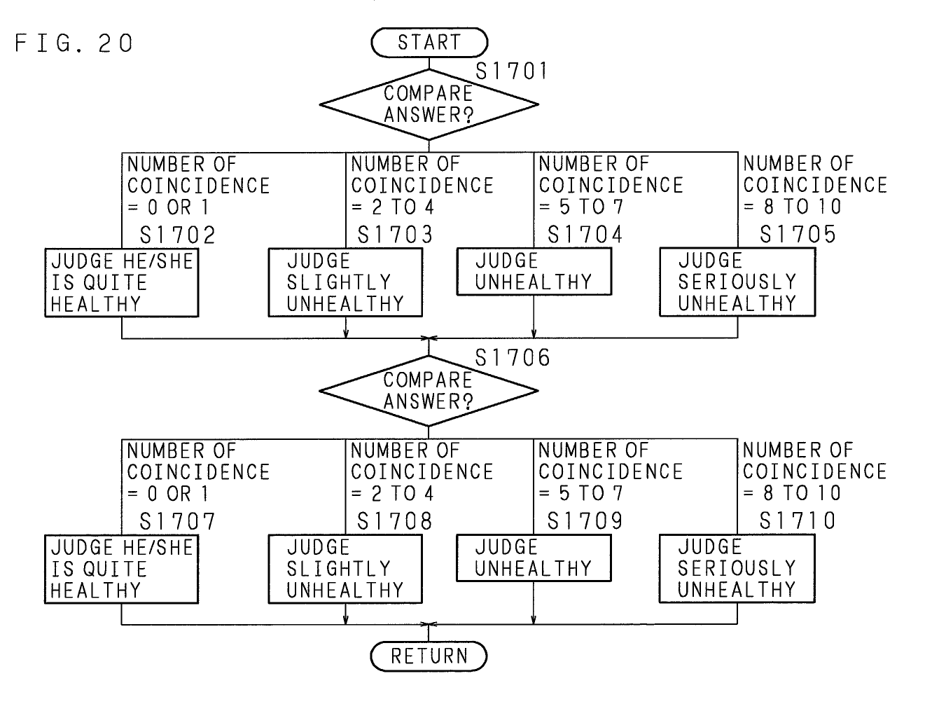

The evaluation process of dialogic diagnosis is described below. FIG. 20 is a flowchart showing the procedure of the evaluation process of dialogic diagnosis. The hard disk drive 34 of the information processing apparatus 3 stores in advance exemplary replies to the questions in the case of unhealthy condition as shown in FIGS. 10 and 11. The information processing apparatus 3 compares the replies by the patient 100 to the questions on life habit obtained from the reply data with the exemplary replies to the questions on life habit stored in advance (Step 1701). When the number of coincident replies is zero or one, it is determined that the life habit is very healthy. In this case, data indicating the contents of “Your life habit is very healthy” is generated as the dialogic diagnosis result (Step 1702), and then the procedure goes to Step 1706. In contrast, when the number of coincident replies falls between 2 and 4 in Step 1701, it is determined that the life habit is somewhat unhealthy. In this case, data indicating the contents of “Your life habit is somewhat unhealthy. Please take care” is generated as the dialogic diagnosis result (Step 1703), and then the procedure goes to Step 1706. When the number of coincident replies falls between 5 and 7 in Step 1701, it is determined that the life habit is unhealthy. In this case, data indicating the contents of “Your life habit is unhealthy. Please take care about meals and exercise” is generated as the dialogic diagnosis result (Step 1704), and then the procedure goes to Step 1706. When the number of coincident replies is 8 or more in Step 1701, it is determined that the life habit is very unhealthy. In this case, data indicating the contents of “Your life habit is very unhealthy. Please consult with the doctor” is generated as the dialogic diagnosis result (Step 1705), and then the procedure goes to Step 1706.

After that, the replies by the patient 100 to the questions on physical condition obtained from the reply data are compared with the exemplary replies to the questions on physical condition stored in advance (Step 1706). When the number of coincident replies is zero or one, it is determined that the physical condition is very healthy. In this case, data indicating the contents of “Your physical condition is very healthy” is added to the dialogic diagnosis result (Step 1707), and then the procedure returns. In contrast, when the number of coincident replies falls between 2 and 4 in Step 1706, it is determined that the physical condition is somewhat unhealthy. In this case, data indicating the contents of “Your physical condition is somewhat unhealthy. Please do not overstrain yourself” is added to the dialogic diagnosis result (Step 1708), and then the procedure returns. When the number of coincident replies falls between 5 and 7 in Step 1706, it is determined that the physical condition is unhealthy. In this case, data indicating the contents of “Your health condition is unhealthy. Please consult with the doctor” is added to the dialogic diagnosis result (Step 1709), and then the procedure returns. When the number of coincident replies is 8 or more in Step 1706, it is determined that the physical condition is very unhealthy. In this case, data indicating the contents of “You can be sick. Please see the doctor” is added to the dialogic diagnosis result (Step 1710), and then the procedure returns.

In Embodiment 1, the questions for dialogic diagnosis has been composed of the questions on life habit and the questions on physical condition. However, the invention is not restricted to this, and the questions for dialogic diagnosis may be composed of only one of these. Alternatively, the questions for dialogic diagnosis may include questions on meals for a diabetic and questions on exercise for a diabetic.

When a doctor 200 introduces a health control system according to the invention to a patient 100, and when the patient 100 purchases a communication device 1 for health control and enters into a health control system according to the invention by virtue of the introduction, the service provider 300 pays a commission to the doctor 200. Further, when the patient 100 enters into the health control system according to the invention, the health insurance association 500 gives a gift such as merchandise coupons to the patient 100.

### Embodiment 2

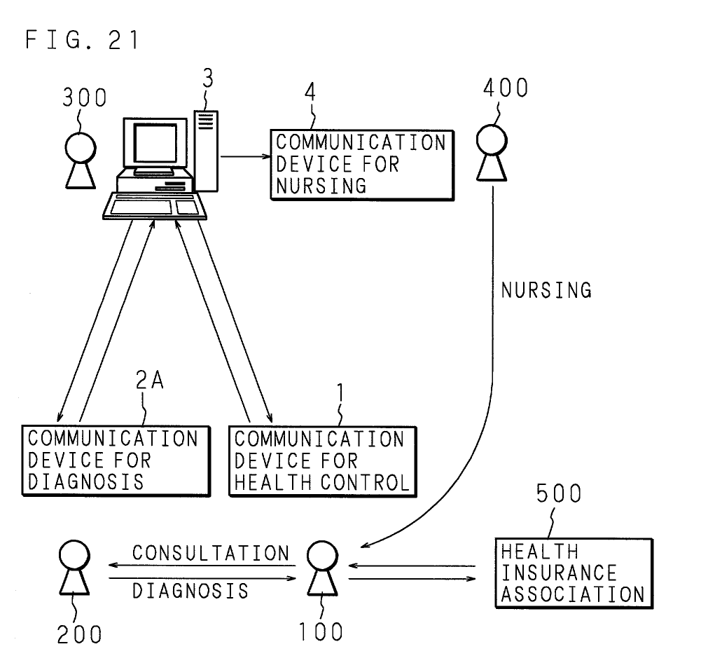

FIG. 21 is a schematic diagram showing the configuration of the main part of a health control system according to Embodiment 2.

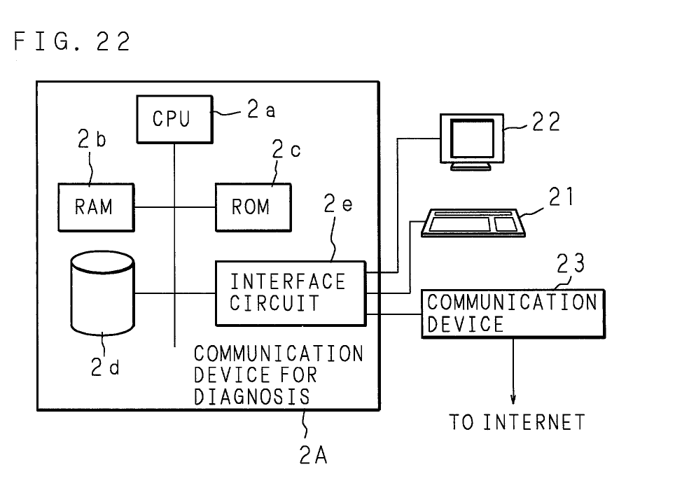

As shown in FIG. 21, the health control system according to Embodiment 2 includes a communication device 2A for diagnosis provided in a hospital or clinic. FIG. 22 is a block diagram showing the configuration of the communication device 2A for diagnosis. The communication device 2A for diagnosis comprises a CPU 2a, a RAM 2b, a ROM 2c, a hard disk drive 2d, and an interface circuit 2e. The interface circuit 2e is connected to: an input device 21 such as a keyboard and a mouse; a display device 22; and a communication device 23 connected to the Internet. By operating the input device 21, a doctor 200 can input chart data of patients into the communication device 2A for diagnosis. The communication device 2A for diagnosis is connected to an information processing apparatus 3 via the Internet. Accordingly, the communication device 2A for diagnosis can transmit the chart data to the information processing apparatus 3, and thereby store the data in the hard disk drive 34 of the information processing apparatus 3. Further, the communication device 2A for diagnosis can request to the information processing apparatus 3 for the chart data, and thereby cause the information processing apparatus 3 to transmit the chart data, whereby the chart data can be retrieved.

Further, the information processing apparatus 3 can collect medical data on up-to-date medical science from the Internet. The communication device 2A for diagnosis can request to the information processing apparatus 3 for the medical data stored in the hard disk drive 34 of the information processing apparatus 3, and thereby cause the information processing apparatus 3 to transmit the medical data, whereby the medical data can be retrieved.

A communication device 1 for health control can receive the result of evaluation of the health condition of a patient 100 carried out by the information processing apparatus 3, by PHS communications. On the basis of the received data, the communication device 1 for health control outputs the name, the calorie consumption, the aerobics hours, the sleeping hours and the deeply sleeping hours, the stress hours, the sleep begin time and the sleep end time, and the dialogic diagnosis result of the patient 100, as a voice message.

The other configuration of the health control system according to Embodiment 2 is similar to that of the health control system according to Embodiment 1, and hence the description is omitted.

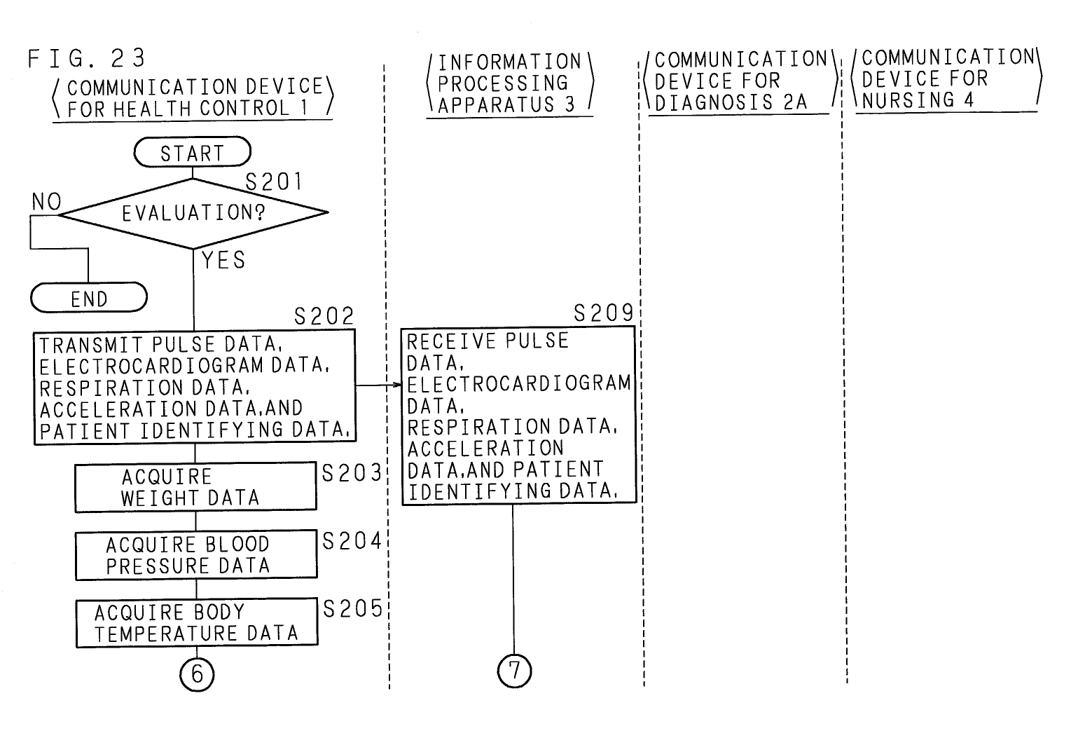

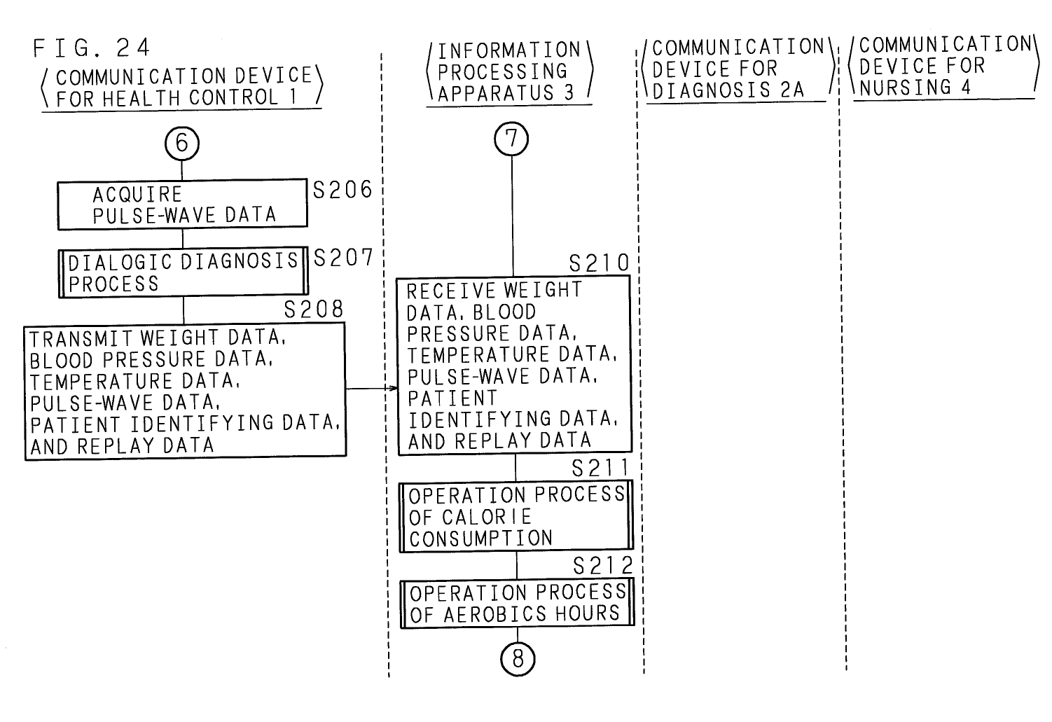

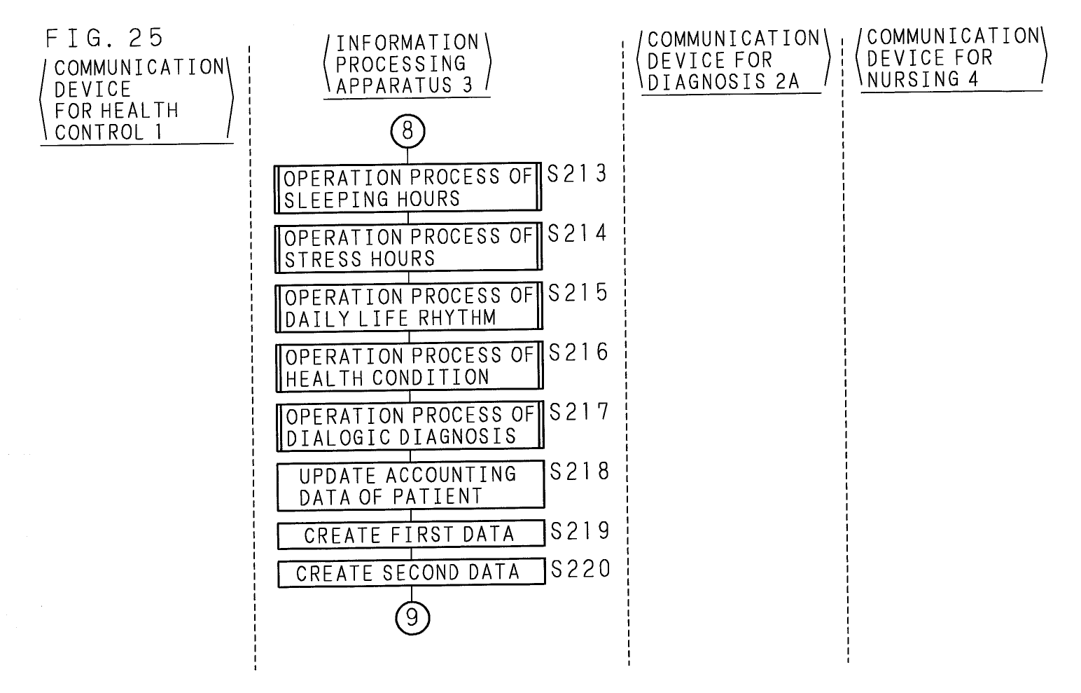

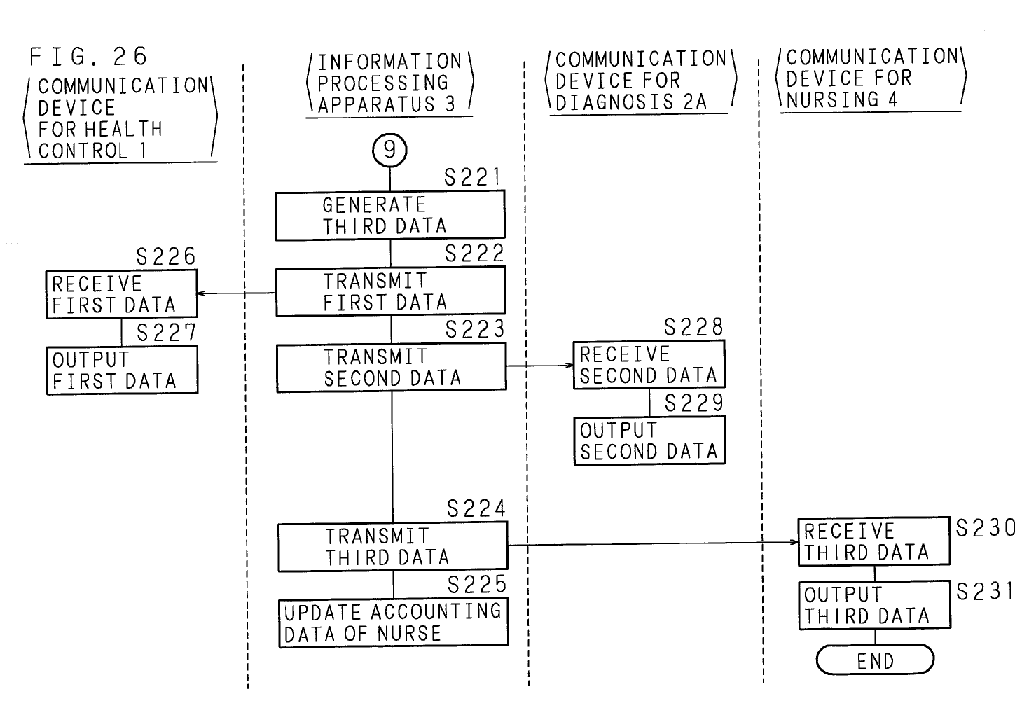

The procedure of the health control system according to Embodiment 2 is described below. FIGS. 23-26 are flowcharts showing the procedure of the health control system according to Embodiment 2. The Steps 201-218 are similar to Steps 1-18 shown in FIGS. 5-7, and hence the description is omitted. In the information processing apparatus 3, identifying information of communication device for health control for specifying the communication device 1 for health control of each patient and identifying information of communication device for diagnosis for identifying the communication device 2A for diagnosis of the physician in attendance for the patient are stored in the hard disk drive 34 in association with the patient identifying information for the patients. The information processing apparatus 3 generates a first data including: the name; the weight; the calorie consumption; the aerobics hours; the sleeping hours and the deeply sleeping hours; the stress hours; the sleep begin time and the sleep end time; the evaluation result; and the dialogic diagnosis result of the patient 100 (Step 219). Further, the information processing apparatus 3 generates a second data including: the name; the weight; the blood pressure; the temperature; the pulse wave; the calorie consumption; the aerobics hours; the sleeping hours; the stress hours; the sleep begin time and the sleep end time; and the dialogic diagnosis result of the patient 100 (Step 220). Furthermore, the information processing apparatus 3 generates a third data including: the name; the weight; the blood pressure; the temperature; the pulse wave; the calorie consumption; the sleeping hours; and the dialogic diagnosis result of the patient 100 (Step 221). The information processing apparatus 3 transmits the first data to the communication device 1 for health control specified by the identifying information of communication device for health control (Step 222), then transmits the second data to the communication device 2A for diagnosis specified by the identifying information of communication device for diagnosis (Step 223), and then transmits the third data to a communication device 4 for nursing (Step 224).

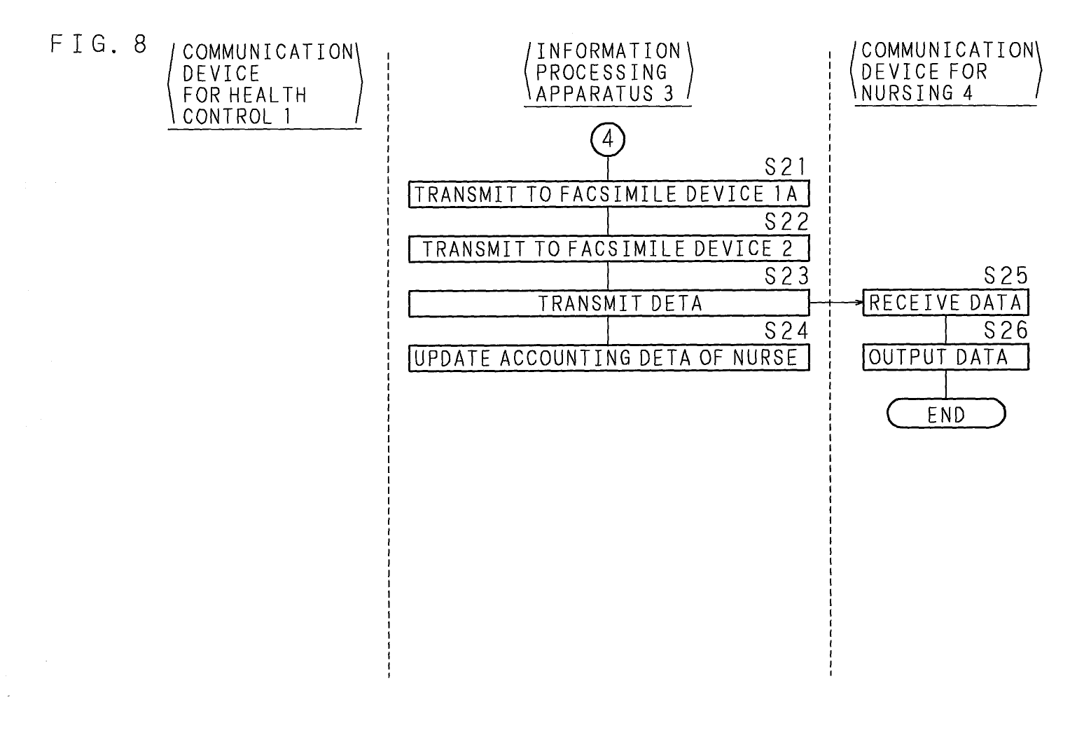

Step 225 is similar to Step 24 shown in FIG. 8, and hence the description is omitted. The communication device 1 for health control receives the first data (Step 226), and then outputs the data as a voice message (Step 227). The communication device 2A for diagnosis receives the second data (Step 228), and then displays the data on a display device 22 (Step 229). Steps 230 and 231 are similar to Steps 25 and 26 shown in FIG. 8, and hence the description is omitted.

In the health control system according to Embodiments 1 and 2, a doctor 200 and a visiting nurse 400 have been incorporated. However, the invention is not restricted to this, and it is possible that either the doctor 200 or the visiting nurse 400 is not incorporated.

Embodiments 1 and 2 have been described for the case that the communication device 1 for health control and the information processing apparatus 3 communicate with each other by PHS communications. However, the invention is not restricted to this, and another communication system such as Cellular system may be used. A wireless communication system also may be used.

In Embodiment 1, the evaluation result of the health condition of the patient 100 carried out by the information processing apparatus 3 has been notified to the patient 100 and the doctor 200 by transmitting the first document data and the second document data to the facsimile machines 1A and 2, respectively. Further, in Embodiment 2, the evaluation result by the information processing apparatus 3 has been notified to the patient 100 and the doctor 200 by transmitting the first data and the second data to the communication device 1 for health control and the communication device 2A for diagnosis, respectively. However, the invention is not restricted to this. That is, the evaluation result may be notified to the patient 100 and the doctor 200 by transmitting the document data indicating the evaluation result to the facsimile machine 1A of the patient 100 and by transmitting the data indicating the evaluation result to the communication device 2A for diagnosis of the doctor 200, respectively. Alternatively, the evaluation result may be notified to the patient 100 and the doctor 200 by transmitting the data indicating the evaluation result to the communication device 1 for health control of the patient 100 and by transmitting the document data indicating the evaluation result to the facsimile machine 2 of the doctor 200, respectively.

Further, in Embodiments 1 and 2, the evaluation result of the health condition of the patient 100 carried out by the information processing apparatus 3 has been notified to the visiting nurse 400 by transmitting the data to the communication device 4 for nursing. However, the invention is not restricted to this. The evaluation result may be notified to the visiting nurse 400 by transmitting the document data indicating the evaluation result to the facsimile machine of the visiting nurse 400. Alternatively, the evaluation result may be notified to the visiting nurse 400 by sending a mail indicating the evaluation result to the visiting nurse 400.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A health control system comprising:
a communication device for health control for acquiring information of health condition indicating the health condition of a target person of diagnosis by a doctor; and
an information processing apparatus capable of communicating with said communication device for health control; wherein:
said communication device for health control includes a processor capable of performing an operation of transmitting said acquired information of health condition and target person identifying information identifying said target person from whom said information of health condition is acquired, to said information processing apparatus; and
said information processing apparatus includes a processor capable of performing the following operations of
evaluating the health condition of said target person on the basis of said received information of health condition; and notifying the evaluation result by said evaluating operation separately to said target person specified by said received target person identifying information and to said doctor carrying out said diagnosis on said target person.

2. A health control system according to claim 1 wherein:
said processor of said information processing apparatus is further capable of performing an operation of storing identifying information of the communication device for health control for identifying said communication device for health control, in association with said target person identifying information;
said evaluating operation is configured so as to generate information of evaluation result indicating the evaluation result of the health condition of said target person to be used for the notification to said target person; and
said notifying operation is configured so as to transmit said information of evaluation result generated by said evaluating operation to said communication device for health control specified by said identifying information of the communication device for health control association with said received target person identifying information.

3. A health control system according to claim 1 further comprising
a communication device for diagnosis used for the diagnosis of the health condition of said target person by said doctor, wherein:
said processor of said information processing apparatus is further capable of performing an operation of storing identifying information of the communication device for diagnosis for identifying said communication device for diagnosis, in association with said target person identifying information;
said evaluating operation is configured so as to generate information of evaluation result indicating the evaluation result of the health condition of said target person to be used for the notification to said doctor; and
said notifying operation is configured so as to transmit said information of evaluation result generated by said evaluating operation to said communication device for diagnosis specified by said identifying information of communication device for diagnosis association with said received target person identifying information.

4. A health control system according to claim 3, wherein:
said communication device for diagnosis includes a processor capable of performing the following operations of:
accepting target person identifying information and chart information indicating the chart of said target person; and transmitting said target person identifying information and said chart information accepted by said accepting operation to said information processing apparatus; and
said information processing apparatus further includes a storage unit of chart information for storing said received chart information in association with said received target person identifying information.

5. A health control system according to claim 1 further comprising:
a communication device for nursing to be used for visit nursing of a target person by a nurse carrying out nursing on said target person, wherein:
said processor of said information processing apparatus is further capable of performing an operation of storing identifying information of the communication device for nursing for identifying said communication device for nursing, in association with said target person identifying information;
said evaluating operation is configured so as to generate information of evaluation result indicating the evaluation result of the health condition of said target person to be used for the notification to said nurse; and
said notifying operation is configured so as to transmit said information of evaluation result generated by said evaluating operation to said communication device for nursing specified by said identifying information of the communication device for nursing association with said received target person identifying information.

6. A health control system comprising:
a communication device for health control for acquiring information of health condition indicating the health condition of a target person of nursing by a nurse; and
an information processing apparatus capable of communicating with said communication device for health control; wherein:
said communication device for health control includes a processor capable of performing an operation of transmitting said acquired information of health condition and target person identifying information identifying said target person from whom said information of health condition is acquired, to said information processing apparatus; and
said information processing apparatus includes a processor capable of performing the following operations of
evaluating the health condition of said target person on the basis of said received information of health condition; and notifying the evaluation result by said evaluating operation separately to said target person specified by said received target person identifying information and to said nurse carrying out said nursing on said target person.

7. A health control system according to claim 1 wherein:
said communication device for health control further includes:
a dialogic diagnosis unit for carrying out dialogic diagnosis on said target person, accepting a reply to a question for dialogic diagnosis, and outputting reply information indicating said accepted reply; and
a detection unit for detecting the physiological condition of said target person and then outputting physiology information indicating said detected physiological condition; and
said health control system is configured so as to transmit said reply information output by said dialogic diagnosis unit and said physiology information output by said detection unit, as said information of health condition to said information processing apparatus.

8. A health control system according to claim 6 wherein:
said communication device for health control further includes:
a dialogic diagnosis unit for carrying out dialogic diagnosis on said target person, accepting a reply to a question for dialogic diagnosis, and outputting reply information indicating said accepted reply; and
a detection unit for detecting the physiological condition of said target person and then outputting physiology information indicating said detected physiological condition; and
said health control system is configured so as to transmit said reply information output by said dialogic diagnosis unit and said physiology information output by said detection unit, as said information of health condition to said information processing apparatus.

9. A health control system according to claim 7 wherein:
said dialogic diagnosis unit includes:
a voice generating unit for generating a plurality of voice messages for dialogic diagnosis; and
a voice recognizing unit for detecting the voice of said target person and then recognizing said detected voice; and
said reply information is generated on the basis of the result of said voice recognition by said voice recognizing unit.

10. A health control system according to claim 7 wherein
said detection unit is attachable to the body of said target person.

11. A health control system according to claim 1 wherein
said processor of said information processing apparatus is further capable of performing an operation of calculating accounting information indicating a charge to said target person depending on the information provided to said target person.

12. A health control system according to claim 3 wherein
said processor of said information processing apparatus is further capable of performing an operation of calculating accounting information indicating a charge to said doctor who uses said communication device for diagnosis.

13. A health control system according to claim 5 wherein
said processor of said information processing apparatus is further capable of performing an operation of calculating accounting information indicating a charge to said nurse depending on the information provided to said nurse.

14. An information processing apparatus comprising a processor capable of performing the following operations of
receiving target person identifying information for identifying a target person of diagnosis by a doctor and information of health condition indicating the health condition of said target person;
evaluating the health condition of said target person specified by said target person identifying information, on the basis of said information of health condition received by said receiving operation; and
notifying the evaluation result by said evaluating operation separately to said target person and said doctor carrying out said diagnosis on said target person.

15. An information processing apparatus according to claim 14 wherein:
said evaluating operation is configured so as to generate information of evaluation result indicating the evaluation result of the health condition of said target person to be used for the notification to said target person; and
said notifying operation is configured so as to transmit said information of evaluation result generated by said evaluating operation, on the basis of said received target person identifying information.

16. An information processing apparatus according to claim 14 wherein:
said evaluating operation is configured so as to generate information of evaluation result indicating the evaluation result of the health condition of said target person to be used for the notification to said doctor; and
said notifying operation is configured so as to transmit said information of evaluation result generated by said evaluating operation, on the basis of said received target person identifying information.

17. An information processing apparatus according to claim 14 wherein:
said evaluating operation is configured so as to generate information of evaluation result indicating the evaluation result of the health condition of said target person to be used for the notification to a nurse; and
said notifying operation is configured so as to transmit said information of evaluation result generated by said evaluating operation, on the basis of said received target person identifying information.

18. A health control system comprising:
a communication device for health control for acquiring information of health condition indicating health condition of a target person of diagnosis by a doctor; and
an information processing apparatus capable of communicating with said communication device for health control; wherein:
said communication device for health control includes transmitting means for transmitting said acquired information of health condition and target person identifying information for identifying said target person from whom said information of health condition is acquired to said information processing apparatus; and
said information processing apparatus includes:
evaluating means for evaluating health condition of said target person on the basis of said received information of health condition;
and notifying means for notifying the evaluation result by said evaluating means separately to said target person specified by said received target person identifying information and to said doctor carrying out said diagnosis on said target person.

19. A health control system comprising:
a communication device for health control for acquiring information of health condition indicating health condition of a target person of nursing by a nurse; and
an information processing apparatus capable of communicating with said communication device for health control; wherein:
said communication device for health control includes transmitting means for transmitting said acquired information of health condition and target person identifying information for identifying said target person from whom said information of health condition is acquired, to said information processing apparatus; and
said information processing apparatus includes:
evaluating means for evaluating the health condition of said target person on the basis of said received information of health condition; and notifying means for notifying the evaluation result by said evaluating means separately to said target person specified by said received target person identifying information and to said nurse carrying out said nursing on said target person.

20. An information processing apparatus comprising:
receiving means for receiving target person identifying information for identifying a target person of diagnosis by a doctor and information of health condition indicating the health condition of said target person;
evaluating means for evaluating the health condition of said target person specified by said target person identifying information, on the basis of said information of health condition received by said receiving means; and
notifying means for notifying the evaluation result by said evaluating means separately to said target person and said doctor carrying out said diagnosis on said target person.
